(19) United States
(12) Patent Application Publication
(10) Pub. No.: US 2008/0101272 A1
(43) Pub. Date: May 1, 2008

(54) Wireless Card and Card Holder for a Digital Camera

(75) Inventors: Gerard James Hayes, Wake Forest, NC (US); Ronald A. Louks, Durham, NC (US); Nadi Sakir Findikli, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/750,383

(22) Filed: May 18, 2007

Related U.S. Application Data
(60) Provisional application No. 60/863,384, filed on Oct. 29, 2006.

(51) Int. Cl. H04Q 7/00

(52) U.S. Cl. 370/313

(57) ABSTRACT

A wireless adapter for a digital camera enables communications between the digital camera and remote devices over a wireless network. The wireless adapter comprises a wireless card and a card holder having a card slot to receive the wireless card. The wireless card is insertable into the card slot of the card holder and includes a wireless interface for communicating with remote devices. A file transfer residing on either the wireless card or card holder receives image data from the digital camera and transfers the image data to a remote device.

### RELATED APPLICATIONS

This application claims the benefit of U.S. Provisional Patent Application 60/863,384 filed on Oct. 29, 2006, which is incorporated herein by reference.

### BACKGROUND

The present invention relates generally to digital cameras and, more particularly, to wireless adapters for digital cameras that enable digital cameras to communicate with remote devices.

A digital camera is an electronic device for capturing and storing images electronically instead of on photographic film. Modern digital cameras have many advantages over conventional film cameras and have virtually replaced film cameras in the marketplace. Digital cameras are small, lightweight, and inexpensive to operate since no film is required. Digital cameras allow consumers to view images immediately after they are captured. Consumers can delete images they do not like and retake images. Images captured can be uploaded to photo libraries on the user's home computer or imported into photo-editing software.

Digital cameras typically include a USB or FIREWIRE port for connecting the digital camera to the user's home computer. A cable plugs into the camera at one end and to the computer at the other end. There are many circumstances in which a user may want to send images wirelessly to remote devices. Because many home computers now have wireless interfaces, it would be convenient for consumers to connect to home computers using a wireless interface. Further, long range wireless interfaces would enable users of digital cameras to access remote devices and services from whatever location the user may currently be in.

To date, wireless interfaces have not been used in digital cameras for several reasons. Wireless interfaces increase the size, weight, and cost of the digital camera. Further, other interfaces in the digital cameras do not provide sufficient power for a wireless transceiver. These design challenges have so far prevented use of wireless interfaces in small, portable digital cameras.

### SUMMARY

The present invention provides a wireless adapter for a digital camera to enable communication between the digital camera and remote devices over a wireless network. The wireless adapter comprises a wireless card including a wireless interface for communicating over wireless networks, and a card holder to receive the wireless card. The card holder may be an integral part of the digital camera, or may be an accessory that detachably mounts to the digital camera. A file transfer agent on either the wireless card or the card holder receives image data from the digital camera and transfers the image data to a remote device over a wireless network. In one exemplary embodiment, the file transfer agent emulates a printer and appears to the digital camera like any other printer.

The present invention may be used, for example, to transfer image files to the user's home computer, to post an image to a web album or web blog, or to send the image to web printing service.

### BRIEF DESCRIPTION OF THE DRAWINGS

FIG. 1 is a schematic diagram of an exemplary wireless networking environment in which the wireless adapter of the present invention may be used.

FIG. 2 illustrates an exemplary wireless adapter for a digital camera according to one exemplary embodiment.

FIG. 3 is a functional block diagram illustrating the components of the wireless adapter according to a first exemplary embodiment.

FIG. 4 is a functional block diagram illustrating the components of the wireless adapter according to a second exemplary embodiment.

### DETAILED DESCRIPTION

Referring now to the drawings, a wireless adapter 100 for a digital camera 10 is shown that enables wireless communications between a digital camera 10 lacking inherent wireless communication capability and remote devices over wireless networks. Remote devices may comprise, for example, a home computer 30, web album 32, web blog 34, or web printing service 36. The wireless adapter 100 can be used with both digital still cameras and digital video cameras.

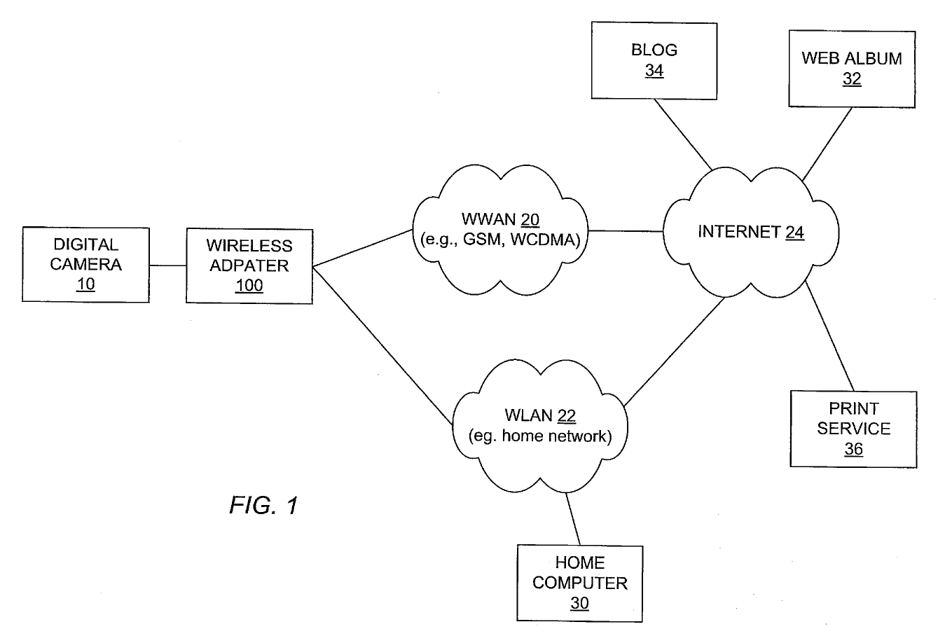

FIG. 1 shows an exemplary networking environment in which the wireless adapter 100 may be used. As will be described in greater detail below, the wireless adapter 100 may connect to a wireless wide area network (WWAN) 20, such as a cellular network or WiMAX network, or to a wireless local area network (WLAN) 22. The WLAN 22 comprises any local area network that can be accessed wirelessly, such as a home network with a wireless router. The WWAN 20 and/or WLAN 22 may provide connection to the Internet 24. A home computer 30 is connected to the WLAN 22. Web album 32, web blog 34, and print server 36 reside are connected to the Internet 24.

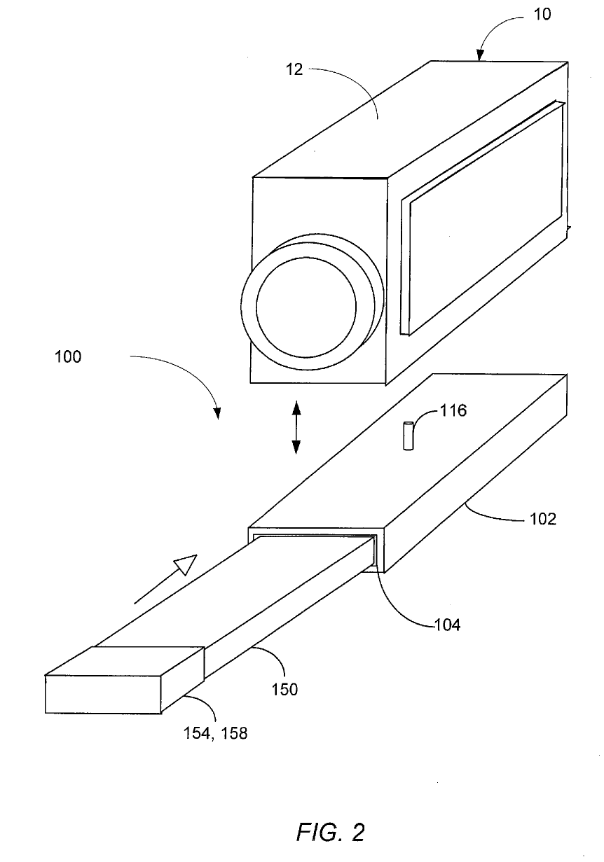

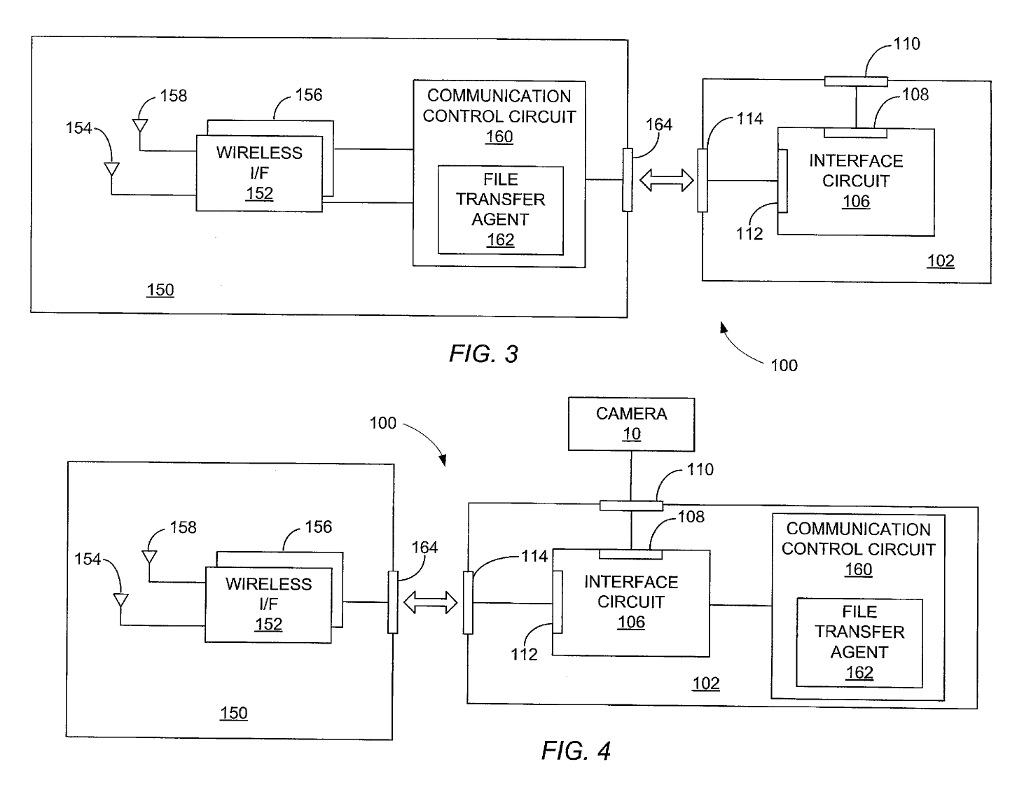

FIG. 2 illustrates an exemplary embodiment of the wireless adapter 100 for a digital camera 10. While the digital camera 10 is illustrated as a digital video camera in this embodiment, the present invention may also be used with digital still cameras. The wireless adapter 100 comprises a card holder 102 having a card slot 104 and a wireless card 150 insertable into the card slot 104 of the card holder 102. The wireless card 150 includes at least one wireless interface 152 (FIG. 3) and antenna 154 for communicating with remote devices (e.g., home computer 30, web album 32, web blog 34, printing service 36) over a wireless network (e.g., WWAN 20, WLAN 22). The card holder 102 may be integrated with the body 12 of the digital camera 10. Alternatively, the card holder 102 may comprises an accessory device that detachably mounts to the digital camera 10 as shown in FIG. 2. In the exemplary embodiment, the card holder 102 includes a mounting screw 116 that detachably connects the card holder 102 to a tripod connector (not shown) on the digital camera 10.

FIG. 3 is a functional block diagram of a wireless adaptor 100 according to a first exemplary embodiment. The card holder 102 in this embodiment includes an interface circuit 106 to interface the wireless card 150 with the digital camera 10. The interface circuit 106 includes a camera interface 108 and a card interface 112. Connector 110 connects the camera interface with the digital camera 10. Connector 114 connects the card interface 112 with the wireless card 150. The interface circuit 106 may implement an industry standard protocol, such as the Universal Serial Bus (USB) protocol, to facilitate communication between the digital camera 10 and the wireless card 150. In this case, interface circuit 106 may function as a USB host controller and the digital camera 10 and wireless card 150 may function as USB clients. If both the digital camera 10 and wireless card 150 implement USB On-The-Go, the interface circuit 106 is not required to function as a USB host controller.

As previously described, the wireless card 150 includes at least one wireless interface 152 coupled to an antenna 154. The wireless interface 152 may comprise a long-range wireless interface for connecting over long distances to a WWAN 20, such as a cellular network (e.g. GSM, CDMA, etc.) or WiMAX network. Alternatively, the wireless interface 152 may comprise a short-range wireless interface (e.g., BLUETOOTH, WiFi, RFID, NFC) for connecting over short distances to a WLAN 22, such as the user's home network. In a preferred embodiment, a second wireless interface 156 and second antenna 158 may also be provided. In this case, the first wireless interface 152 can be used to connect over long distances to WWANs 20. The second wireless interface 156 may be used to connect over short distances to WLANs 22.

The wireless card 150 further includes a communication control circuit 160 for controlling the operation of the wireless card 150. The communication control circuit 160 includes processing circuits and memory to enable communication over wireless networks. The processing circuits may comprise one or more processors and/or processing hardware. Connector 164 connects the communication control circuit 160 with the card holder 102. The communication control circuit 160 includes a file transfer agent 162, which can be implemented as a software application on a processor. The file transfer agent 162 provides remote access capability to the digital camera 10. The file transfer agent 162 stores information about one or more remote destinations. Such information includes, for example, the destination address for each destination and authentication information, such as the username and password for each destination. The file transfer agent 162 is configured to receive image data from the digital camera 10 and transfer the image data to the remote destination via one of the wireless interfaces 152, 156.

In one embodiment, the file transfer agent 162 emulates a printer as described in related Application Ser. No. 60/863,382, filed concurrently herewith and incorporated herein by reference. In this embodiment, file transfer agent 162 implements PictBridge or other direct printing technology to communicate directly with the digital camera 10. The file transfer agent 162 can create one or more emulated printers that appear to the digital camera 10 like any other printer. When the user “prints” to an emulated printer, the file transfer agent 162 transfers the image data to a corresponding remote destination. By emulating a printer, wireless adaptor 100 provides networking capabilities to any digital camera 10 that can connect directly to a printer.

FIG. 4 illustrates another exemplary embodiment of the wireless adapter 100. This embodiment is similar to the previous embodiment and the same reference numbers have been used to indicate components that are the same. As shown in FIG. 4, the card holder 102 includes an interface circuit 106 as previously described with a camera interface 108 and card interface 112. The wireless card 150 includes first and second wireless interfaces 152, 156 coupled to first and second antennas 154, 158 respectively. In this embodiment, the communication control circuit 160 and the file transfer agent 162 reside in card holder 102 instead of wireless card 150. The wireless card 150 functions as a modem. The file transfer agent 162 functions as previously described. One advantage of this arrangement is that the card holder 102 can be used with an industry standard wireless card 150.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless adaptor for a digital camera, said wireless adaptor comprising:
a card holder having a slot to receive a wireless card for communicating with remote devices over a wireless network; and
an interface circuit configured to electrically connect said wireless card with said digital camera.

2. The wireless adaptor of claim 1 further comprising a connector to detachably connect said card holder to said digital camera.

3. The wireless adaptor of claim 1 wherein the interface circuit includes a first interface for communicating with said digital camera and a second interface for communicating with said wireless card.

4. The wireless adaptor of claim 3 wherein said first interface comprises a serial interface.

5. The wireless adaptor of claim 4 wherein said second interface comprises a serial interface.

6. The wireless adaptor of claim 5 wherein said first and second interfaces comprise Universal Serial Bus (USB) interfaces, and wherein said interface circuit comprises a USB host controller.

7. The wireless adaptor of claim 1 further comprising a wireless card insertable into said slot in said card holder, wherein said wireless card includes a wireless interface for communicating with remote devices over a wireless network.

8. The wireless adaptor of claim 7 wherein said wireless card includes a file transfer agent configured to receive image data from said digital camera and to transfer said image data to a specified destination device via the wireless interface.

9. The wireless adaptor of claim 8 wherein the file transfer agent is configured to emulate a printer.

10. A wireless card for use with a digital camera, said wireless card comprising:
a wireless interface configured to communicate with remote devices over a wireless network; and
a file transfer agent configured to receive image data from said digital camera and to transfer the image data to a specified destination device via the wireless interface.

11. The wireless card of claim 10 wherein the file transfer agent emulates a printer.

12. The wireless card of claim 10 further comprising a first interface configured to communicate with the adaptor of claim 1.

13. The wireless card of claim 12 wherein the first interface comprises a serial interface.

14. The wireless card of claim 13 wherein the first interface comprises a Universal Serial Bus (USB) interface.

15. A wireless adaptor for a digital camera, said wireless adaptor comprising:
a card holder having a slot to receive a wireless card for communicating over a wireless network;
a file transfer agent configured to receive image data from said digital camera and to transfer said image data received from the digital camera to a specified remote destination using said wireless interface; and
an interface circuit configured to interface said file transfer agent with said digital camera and said wireless card.

16. The wireless adaptor of claim 15 wherein the file transfer agent is configured to emulate a printer.

17. The wireless adaptor of claim 15 further comprising a connector to detachably connect said card holder to said digital camera.

18. The wireless adaptor of claim 15 wherein said interface circuit includes a camera interface to interface with said digital camera and a card interface to interface with said wireless card.

19. The wireless adaptor of claim 18 wherein said camera interface comprises a serial interface.

20. The wireless adaptor of claim 19 wherein said card interface comprises a serial interface.

21. The wireless adaptor of claim 20 wherein said camera and card interfaces comprise Universal Serial Bus (USB) interfaces.

22. The wireless adaptor of claim 21 wherein said interface circuit comprises a USB host controller.
